(19) United States
(12) Patent Application Publication
(10) Pub. No.: US 2003/0017771 A1
(43) Pub. Date: Jan. 23, 2003

(54) Textile lattice for reinforcing bitumen-bonded layers

(76) Inventors: Jurgen Kassner, Gescher (DE); Heiko Pintz, Nordhorn (DE); Ulrich Von Fransecky, Bocholt (DE)

Correspondence Address: Choate, Hall & Stewart, Patent Group, Exchange Place, 53 State Street, Boston, MA, 02109-2804, US

(21) Appl. No.: 10/245,536

(22) Filed: Sep. 17, 2002

(30) Foreign Application Priority Data
Dec. 17, 1996 (DE) 196 52 584.5

(51) Int. Cl. B32B 11/10; B32B 11/02; B32B 27/12; B32B 27/04; B32B 5/02; B32B 5/26

(52) U.S. Cl. 442/48; 442/1; 442/20; 442/43; 442/35; 442/49

(57) ABSTRACT

The invention relates to a wide-meshed, textile lattice to provide reinforcement for bitumen-bonded layers, in particular of road surfacing, which is coated with a bonding compound having an affinity for bitumen and essentially consisting of two sets of parallel, load-bearing threads (1, 2), whereby one set of threads (1) extends in the longitudinal direction of the lattice and the other set of threads extends in the direction perpendicular to the longitudinal direction of the lattice and the threads (1, 2) are of glass fibres or chemical fibres such as polymer fibres or polycondensate fibres.

In order to develop a reinforcing lattice for bitumen-bonded layers which provides a better bond with a pre-prepared formation than the known lattices, the over-crossed threads (1, 2) are secured to a thin fleece (3) by Raschel-locking, whereby the binding Raschel-locking threads (5) surround the longitudinally extending threads (1) of the lattice and secure the threads (2) extending transversely.

The invention relates to a wide-meshed, textile lattice to provide reinforcement for bitumen-bonded layers, in particular of road surfacing, essentially consisting of two sets of parallel, load-bearing threads, whereby one set of threads extends in the longitudinal direction of the lattice and the other set of threads extends transversely to the longitudinal direction of the lattice and the threads are made from glass fibers or chemical fibers such as polymer fibers or polycondensate fibers and are Raschel-locked onto a fleece, whereby the connecting Raschel-locking threads surround the longitudinally extending threads of the lattice and secure the transversely extending threads.

The lattice may be woven or Raschel-locked but alternatively the load-bearing parallel threads running transversely to the longitudinal direction may be laid on the load-bearing parallel threads and bonded to the longitudinal threads at the intersecting points by bonding and welding.

A lattice bonded to a fleece of this type is known from publication EP 0 413 295 A. The geo-textile used for reinforcing layers of asphalt known from this publication is a bonding material consisting of two components, one of these components being a fleece and a second of these components a woven fabric, knitted fabric, thread pattern, lattice or any other flat layout having a defined yarn position. The bonding material is provided as a Raschel-locked material in which the two components are integrated one in the other by means of an end-latching Raschel technique. The fleece is designed to have a good capacity for absorbing bitumen so that when the geo-textile is laid down, this fleece becomes impregnated with bitumen and acts as a barrier to water. The fleece is also intended as a means of preventing the occurrence of tearing and the propagation of tearing in the layers of asphalt. The weight of the fleece by surface area should be 50 to 300 g/m², preferably 100 to 180 g/m². This geo-textile forms a separating layer in the installed state.

DE 20 00 937 discloses a wide-meshed textile lattice for reinforcing road surfacing, which is pre-fabricated so that it is coated with a specific bonding substance having an affinity to bitumen, e.g. a bitumen-latex emulsion, in order to produce a good adhesion between the lattice and the bitumen bonded layers.

In order to obtain a firm bond between the layers of the road surfacing on the two sides of the reinforcing lattice, there is an advantage to be had if the lattice is made with a wide mesh so that the distance between the parallel threads in the longitudinal direction and those in the transverse direction is 20 to 100 mm. The mesh width should be determined on the basis of the largest grain diameter of the surfacing mixture to be used. Advantageously, the mesh width is 2 to 2.5 times greater than the largest grain diameter. The load-bearing threads in the longitudinal and transverse directions should have a breaking strength of from 10 to 100 kN/m. If necessary or desirable, even stronger threads can be used for the reinforcing lattice.

As a result of the coating of bonding substance, the lattice is of a semi-rigid consistency. The lattice, which is 5 m wide and 30 or 50 m long, for example, is rolled out onto a surface which has been evenly sprayed with a bonding compound or bitumen emulsion. The reinforcing lattice should be laid out flat and free of folds before any further surfacing mixture is applied to the reinforcing lattice. In the case of these known lattices, a difficulty arises in that once rolled out, the reinforcing lattice slides causing creases, particularly when vehicles are driven over the laid-out lattice.

The underlying objective of the invention is to develop a reinforcing lattice for bitumen-bonded layers which does not act as a separating layer between these layers and which provides better bonding than the known lattices on a pre-prepared road level.

This objective is achieved by the invention due to the fact that the fleece has a weight of 10 to 50 g/m² and that the load bearing threads are treated and coated together with the fleece, with a bonding substance having an affinity to bitumen, the fleece having openings in the coating of bonding substance and being perforated in order to be permeable to air.

Due to the fact that the mesh of the lattice is filled with a thin fleece, a significantly stronger bond is produced when the lattice is laid on the formation. On the other hand, the fleece is so thin and consequently so flexible that the fleece does not act as a separating layer between the asphalt layers underneath and above the lattice. In spite of the existence of the fleece, nevertheless a firm keying action between the coarse grains of the surfacing mixture laid on top of the lattice and the coarse grains of the surfacing mixture underneath the lattice is achieved.

Due to the fact that the load-bearing threads of the lattice in the direction of the warp are lashed by the Raschel locking threads, the load-bearing threads running at right-angles thereto are fixed at their respective distances from one another.

In another variant of the embodiment of the invention, there is no need for the lattice to be impregnated or coated with a bonding compound having an affinity for bitumen if the load-bearing threads are made from a polymer or a polycondensate, which in itself provides a firm bond with bitumen.

Furthermore, the underside of the composite of the textile lattice and the thin fleece may be provided with a bituminous mastic. This bituminous mastic melts when the hot asphalt mixture needed to form the bituminous surfacing is deposited on the laid lattice matting. It is advantageous to apply the bituminous mastic only in spots or stripes parallel with the winding axis in order to preserve the flexibility of the reinforcing lattice. The quantity of the bitumen-latex emulsion to be sprayed on the road level is considerably reduced by the bituminous mastic on the composite and may even be omitted completely. The installation of the lattice is simplified and the time for installing the reinforcement is reduced. The quantity of the mastic to be applied depends on the condition of the asphalt or road surfacing to be renewed. It ranges preferably from 150 g to 500 g/m².

Further characterizing features of the invention are specified in claims 2 to 12.

The description given below, in conjunction with the appended drawings, provides an explanation of an embodiment of the invention. Of the drawings,

FIG. 1 is a plan view of a reinforcing lattice of the invention,

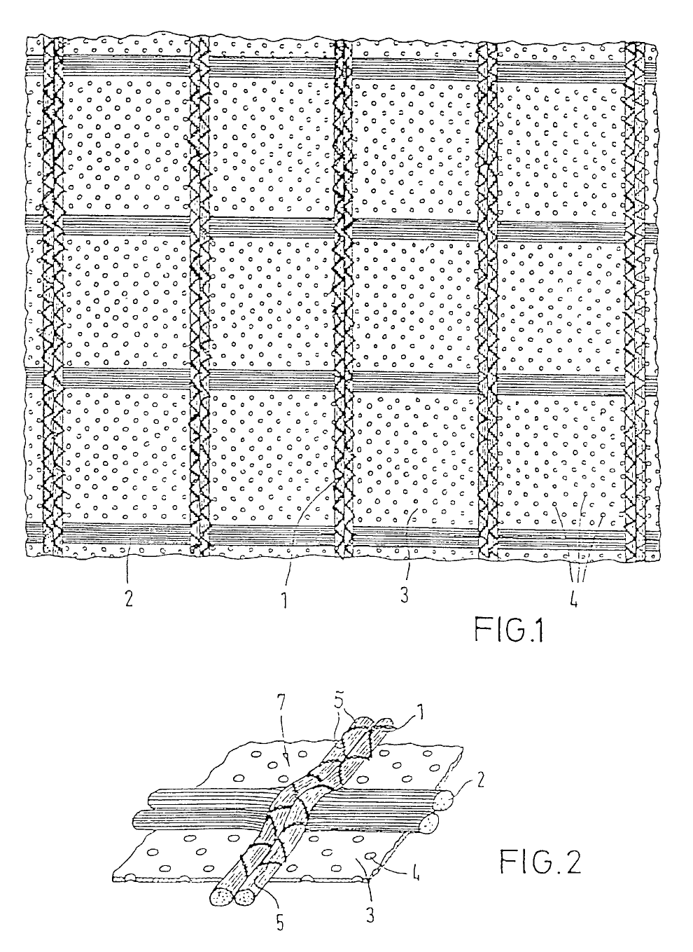

FIG. 2 is a detail of a cross-over point of the reinforcing lattice, and

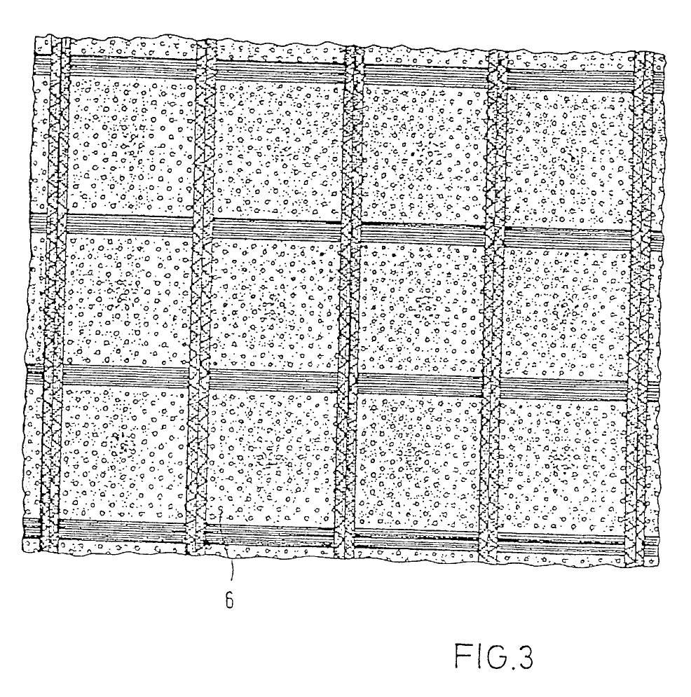

FIG. 3 shows a reinforcing lattice such as that of FIG. 1 coated with a bonding compound.

The textile lattice for providing reinforcement for bitumen-bonded layers illustrated in FIGS. 1 to 3 essentially consists of two sets of parallel load-bearing threads 1 and 2. The threads 1 of the lattice run in the direction of the warp or longitudinal direction of the lattice whilst the threads 2 run transversely thereto. The load-bearing threads are made from highly modular polymer fibers or polycondensate fibers, for example fibers made of aramide or polyvinyl alcohol, in particular in the form of endless fibers. However, the load-bearing fibers may also be glass fibers. The threads 1 extending longitudinally, each made up of two bundles of fibers in the embodiment illustrated, are surrounded by Raschel locking threads 5, which join the longitudinally extending threads 1 as well as the transversely extending threads 2 to a thin fleece 3. As can be seen with particular clarity from FIG. 2, the threads 2 extending transversely are arranged between the fleece 3 and the threads 1 which extend longitudinally. This layout is more stable than an arrangement whereby the threads 2 extending transversely run across the longitudinally extending threads 1. The load-bearing threads 1 and 2 may be impregnated or coated with a bonding compound even before they are secured to the fleece 3 by Raschel-locking. For practical purposes, however, the load-bearing threads 1 and 2 are coated with the bonding compound 6 on the fleece 3. In order to keep the consumption of bonding compound, in particular a bitumen-latex emulsion, within limits, the layer applied is so thin that the fleece 3 is still permeable to air.

As can be seen particularly clearly from FIGS. 1 and 2, the fleece 3 is perforated. Holes 4 of a 0.5 to 4 mm diameter are punched through the fleece in a regularly distributed pattern. The proportion of holes in relation to the total surface area of the fleece is at least 10%.

The fleece 3, which is made from PETP, PET or PP fibers, threads or filaments and hardened by heat, chemical or mechanical processing, weighs from 10 to 50 g/m².

The Raschel threads 5 used to secure the lattice are perfectly adequate as a rule. In specific circumstances, however, the load-bearing threads may also be additionally bonded to one another by bonding or welding at their cross-over points.

In order to produce a firm bond for the layers of an asphalt surfacing, it is an advantage if the load-bearing threads 1 and 2 are not flat but rounded and of a diameter of from 2 to 4 mm.

A bituminous mastic melting at 60° C. is applied to the lower surface of the reinforcing lattice in form of spots (not shown) or stripes parallel to the rolling axis in order to preserve the flexibility of the composite comprising the lattice 1, 2, the fleece 3, the coating 6 having an affinity for bitumen and meltable bituminous mastic is preserved.

Reference Numerals

1 load-bearing threads in the longitudinal direction of the lattice

2 load-bearing threads in the transverse direction of the lattice

3 fleece

4 perforations

5 Raschel locking threads

6 bonding compound

7 cross-over point

1. A wide-meshed, textile lattice to provide reinforcement for bitumen-bonded layers, in particular of a road surfacing, which essentially consists of two sets of parallel, load-bearing threads (1 and 2) whereby one set of threads (1) extends in the longitudinal direction of the lattice and the other set of threads (2) extends transversely to the longitudinal direction of the lattice and the threads (1 and 2) are of glass fibers or chemical fibers such as polymer fibers or polycondensate fibers and are Raschel-locked on the fleece (3), whereby the connecting Raschel-locking threads (5) surround the longitudinally extending threads (1) of the lattice and secure the transversely extending threads (2), characterized in that the fleece (3) has a weight of 10 to 50 g/m² and that the load-bearing threads (1 and 2) are treated and coated together with the fleece, with a bonding substance having an affinity to bitumen, the fleece having openings in the coating of bonding substance and being perforated in order to be permeable to air.

2. A lattice as claimed in claim 1, characterized in that holes of a diameter of from 0.5 to 4 mm are punched in the fleece (3) in a regularly distributed pattern and the proportion of holes in relation to the total surface area is at least 10%.

3. A lattice as claimed in claim 1 or 2, characterized in that a bituminous mastic which can be activated by heating is applied to the underside of the composite, especially of the fleece (3).

4. A lattice as claimed in claim 3, characterized in that the bituminous mastic is deposited in form of spots or stripes extending transversely or orthogonal to the longitudinal direction of the lattice.

5. A lattice as claimed in on of claims 1 to 4, characterized in that the transversely extending threads (2) are arranged between the fleece (3) and the longitudinally extending threads (1).

6. A lattice as claimed in one of claims 1 to 5, characterized in that the load-bearing threads (1 and 2) are joined to one another at their cross-over points (7) by bonding or welding.

7. A lattice as claimed in one of claims 1 to 6, characterized in that the load-bearing threads (1 and 2) are in the form of rounded 2 to 4 mm diameter strands or double strands secured to the fleece (3) by Raschel-locking.

8. A wide-meshed lattice for providing reinforcement for bitumen-bonded layers, in particular for road surfacing, essentially consisting of two sets of parallel, load-bearing threads (1 and 2), whereby one set of threads (1) extends in the longitudinal direction of the lattice and the other set of threads (2) extends perpendicularly to the longitudinal direction of the lattice and the threads (1 and 2) are of chemical fibers such as polymer fibers or polycondensate fibers and the crossing threads (1, 2) of the lattice are Raschel-locked onto a fleece (3), the connecting Raschel-locking threads (5) surrounding the longitudinally extending threads (1) and securing the transversely extending threads (2), characterized in that the threads (1, 2) of the lattice are made from a material with an affinity for bitumen, in particular a bitumen bonding substance and the fleece has a weight of less than 50 g/m2.
